(19) United States
(12) Patent Application Publication
(10) Pub. No.: US 2021/0355673 A1
(43) Pub. Date: Nov. 18, 2021

(54) FIRE-RESISTANT BAMBOO STRUCTURAL BUILDING MATERIAL

(71) Applicant: Bamboo Ecologic Corporation, Bradenton, FL (US)

(72) Inventors: David Elliott Sands, Pahoa, HI (US); Sean Michael Costello, Edmonds, WA (US)

(21) Appl. No.: 17/320,797

(22) Filed: May 14, 2021

Related U.S. Application Data
(60) Provisional application No. 63/025,931, filed on May 15, 2020.
(60) Provisional application No. 63/112,501, filed on Nov. 11, 2020.
(60) Provisional application No. 63/112,705, filed on Nov. 12, 2020.

(51) Int. Cl. E04B 1/10; B32B 3/18; B32B 21/04; B32B 21/13; B32B 21/14; B27K 3/16; B27M 3/00

(52) U.S. Cl. CPC E04B 1/10; B32B 3/18; B32B 21/042; B32B 21/13; B32B 21/14; B32B 2419/00; B27M 3/0086; B27K 2200/30; B27K 2240/30; B32B 2307/3065; B32B 2307/764; B27K 3/16

(57) ABSTRACT

Bamboo lumber products and fabrication techniques thereof are provided. Thick-wall bamboo culm is cut into multiple slats, each made up of a solid portion of culm. The slats are laminated, joined, or otherwise combined to form solid panels, boards, or other lumber products. The use of thick-walled bamboo and associated processes as disclosed allows for lumber products that have a lower glue-to-bamboo ratio and therefore provide superior characteristics compared to conventional techniques and products.

### 1 CROSS REFERENCE TO RELATED U.S. PATENT APPLICATIONS

The present application claims priority under 55 U.S.C. § 119(e) to provisional U.S. Patent Application Ser. No. 63/025,931 (Docket No. B1129-000200US) filed May 15, 2020, provisional U.S. Patent Application Ser. No. 63/112,501, filed Nov. 11, 2020, and provisional U.S. Patent Application Ser. No. 63/112,705 (Docket No. B1129-000301US) filed Nov. 12, 2020, each of which is incorporated herein by reference in its entirety and for all purposes.

### 2 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2019-2020, Bamboo Ecologic Corporation, dba Rizome.

### 3 BACKGROUND OF THE TECHNOLOGY

### 3.1 Field of the Technology

The exemplary, illustrative, technology herein relates to the creation of engineered bamboo structural building materials constructed from solid bamboo slats, more particularly, engineering bamboo lumber and other building materials fabricated from the same.

### 3.2 Background

### 3.2.1 Wood Construction Materials

Wood studs have been commonly used for wall construction for many decades. Wood-based products have numerous advantages and disadvantages when used as a building material. Wood is characterized as either softwood or hardwood, based in part upon its cellular structure and characteristics. Both softwood and hardwood are grown as trees which are subsequently harvested and cut into dimensional lengths for building construction and other uses.

Softwood is wood from gymnosperm trees, e.g. pine or spruce. The cell structure of softwood is in the form of medullary rays, which radiate outward from the center of the tree. Tracheids, or a type of water-conducting cell, help move water throughout softwoods. Untreated softwoods have fire resistance rating rangings as shown in Table 1, but are the most-used wood in the construction industry because of their fast growth rate and low cost to produce. The length of softwood fibers are typically about 1-4 mm long.

Hardwood is wood from angiosperm trees, e.g. trees that flower, including oak, maple, and walnut trees. Hardwoods have vessels that transport water throughout the tree, resulting in a harder wood structure. The length of hardwood fibers are about 1 mm long.

Both softwood and hardwood are grown in trees which can be harvested and cut into dimensional lumber. Lumber is a piece of material cut such that its thickness is greater than 3 mm (⅛″). Veneer is a thin piece of material cut with a thickness ranging between 0.3 mm-3 mm ( 1/64″-⅛″). The trees being harvested for most construction in the US are cut younger than in the past, which means they have a higher percentage of sap wood, resulting in lumber with lower structural performance, lower aesthetic value, and greater susceptibility to fire.

The term “lumber” describes wood products cut from a tree, typically with the wood grain running longitudinally (along the length) of the wood product. “Dimensional lumber” is lumber of specific well known sizes (e.g. nominal 2″×4″×8′, which is 1.5″×3.5″×8′ in length after processing). The term “engineered lumber” is used for wood-based products have the general size, shape, and grain characteristics of lumber or dimensional lumber, but is constructed using engineering techniques including laminating smaller pieces or strips of lumber together to make larger pieces or by creating trusses or other engineering structures using lumber. Panels are lumber or engineered lumber which are generally rectilinear and are characterized by two relatively larger surfaces forming “faces”, and four surfaces forming edges. Wooden mass timber describes a composite material created by assembling lumber pieces in order to create larger, structural (e.g. load bearing) materials.

Engineered Timber includes cross laminated timber (CLT), nail laminated timber (NLT), glue laminated timber, dowel laminated timber (DLT), and structural composite panels of varying types (e.g. laminated veneer lumber (LVL) and laminated strand lumber (LSL)), each typically made of hard- or softwoods. Mass Timber is a category of engineered structural timber in which lumber is used to create large panels for wall, floor, and roof construction, resulting in very large panels.

Existing CLT comprises layers (typically three, five, or seven) of wood dimensional lumber oriented at right angles to each other and then glued to form structural panels. CLT suffers from the structural inconsistencies of newly harvested dimensional lumber described within, and is subject to the structural characteristics of that lumber.

Existing NLT is created from individual wood dimensional lumber, stacked on edge, and fastened through the faces with screws or nail to create a structural element. Like CLT, NLT suffers from the irregularities of newly harvested dimensional lumber and the inherently variable structural characteristics it imparts.

Glued laminated timber is stress-rated, engineered, structural wood members typically created by binding layers of hardwood or softwood veneers or chips (strands) together with a structural adhesive to create a member with differing structural characteristics than its individual components. Plywood is an exemplar glue laminated veneer (LVL). OSB is an exemplar laminated strand lumber (LVL). Glue laminates generally have greater strength and stiffness than the wood they are made of. Bamboo LVL created using crushed or flattened bamboo culm are known in the art.

The limitations of current wood CLT and LVL products is that much of the wood currently cut for construction has low structural values since the trees are cut younger. Therefore thicker panels and larger beams and columns are required to meet the structural requirements of a building. The thicker panels add to the weight and cost of the structures.

### 3.2.1.1 Inflammability of Wood Products

Of critical concern with wood buildings, especially multistory buildings, is the inflammability of wood and wood-based product. The inflammability of the wood limits the number of stories and in many cases requires the coverage of structural wood elements with fire rated drywall or other fire protective material. Furthermore, current CLT and LVL products and mass timber products created using these techniques require additional fire protection techniques be applied to protect them when used as structural elements of buildings. These techniques include covering the surfaces with a fire-resistant material such as gypsum board or a cementitious coating, or painting them with a fire-resistant paint. These techniques provide fire resistance and flame spread resistance by covering the wood products and do not make the wood product itself fire proof or flame resistant. Additionally, these product cover the wood grain, destroying the aesthetic beauty of the natural wood.

Recently, fire resistance and flame spread resistant materials for direct application to wood products have been introduced. These products act by binding with available oxygen when heated, which limits fire spread.

Flame spread resistance of building materials is characterized using a standardized test that are part of the ASTM 1988a standard, test E84, which results in a flame spread rating index in the range of 1-200. The resulting index values are grouped further as class I/A (1-25), class IUB (26-75), and class III/C (76-200). Untreated wood products have varying flame spread resistance, based in part upon the lumber's moisture content, cellular structure, density, and other wood-species related attributes. Glue laminate products have flame spread resistance and fire reaction characteristics related to the materials used to construct the glue laminate product. Surface treatments are available to improve the flame spread resistance rating of various lumber products; these treatments cover the lumber with a barrier to protect the wood from flames.

Fire resistance of building materials is characterized using various standardized classification methods (and tests), e.g. EU 13501-1 (reaction to fire) and EU-13501-2 (resistance to fire). EU 13501 provides a number of fire performance criteria for materials' fire reaction representing flame spread, contribution to fire, and generation of smoke/flaming droplets. The standards describe an assessment of a fire resistance class ranging from A-1, A-2, through F, with class A having little or no involvement in the fire, and class F being highly inflammable.

Table 1 illustrates fire-related characteristics of common untreated woods.

TABLE 1
Reported Characteristics of Solid Wood Products

| | ASTM E84 | | ASTM E84 | |
|---|---|---|---|---|
| | Flame | | Smoke | |
| | Spread | Janka | Developed | |
| Material | Index/Class | rating | Index | Source |
| Alder | 80/C | | 165 | HPVA T-14189 (2013) |
| Aspen | 105/C | 380 | 45 | Exova 15-002-475(C1) (2015) |
| Birch, Yellow | NA/C | 1260 | NA | UL527 (1971) |
| Cedar, Alaska | 40/B | | 140 | HPVA T-15591 (2017) |
| Cedar, Alaska Yellow | 50/B | | 115 | HPVA T-12704 (2008) |
| Cedar, Eastern White | 40/B | | 200 | HPVA T-15318 (2017) |
| Cedar, Incense | 45/B | | 150 | HPVA T-15204 (2016) |
| Cedar, Port Orford | 60/B | | 150 | HPVA T-12694 (2008) |
| Cedar, Western Red | 45/B | | 125 | HPVA T-15172 (2016) |
| Cottonwood | NA/C | | NA | UL527 (1971) |
| Cypress | 75/B | 1375 | 200 | HPVA T-14530 (2014) |
| Douglas-fir | 70/B | 660 | 80 | HPVA T-14253 (2013) |
| Fir, Balsam | 45/B | | 105 | HPVA T-15557 (2017) |
| Fir, White | 40/B | | 80 | HPVA T-15088 (2016) |
| Gum, Red | NA/C | | NA | UL527 (1971) |
| Hem-Fir Species Group³ | 60/B | | 70 | HPVA T-10602 (2001) |
| Hemlock, Eastern | 35/B | | 175 | HPVA T-15320 (2017) |
| Hemlock, Western | 40/B | | 60 | Exova 15-002-475(A1) (2015) |
| Maple (flooring) | NA/C | | 155 | CWC FP-6 (1973) |
| Maple (rough sawn) | 35/B | 1450 | 250 | HPVA T-14573 (2014) |
| Oak, Red or White | NA/C | 1290 | NA | UL527 (1971) |
| Pine, Eastern White | 70/B | | 110 | HPVA T-14186 (2013) |
| Pine, Idaho White | NA/B | | 125 | HPVA T-592 (1974) |
| Pine, Jack | 50/B | | 165 | HPVA T-15556 (2017) |
| Pine, Lodgepole | 75/B | | 140 | HPVA T-15029 and T-15069 (2015) |
| Pine, Ponderosa | 55/B | | 135 | HPVA T-15067 (2016) |
| Pine, Red | 115/C | | 65 | Exova 15-002-475(B1) (2015) |
| Pine, Southern Yellow | 70/B | 870 | 165 | HPVA T-14254 (2013) |
| Pine, Sugar | 45/B | | 110 | HPVA T-15068 (2016) |
| Pine, Western White | NA/B | | NA | UL527 (1971) |
| Poplar, Yellow | 125/C | 340 | 125 | HPVA T-14512 (2014) |
| Redwood | 55/B | | 135 | HPVA T-14185 and T-14243 (2013) |
| Spruce, Black | 45/B | | 250 | HPVA T-14053 (2013) |
| Spruce, Eastern Red | 65/B | | 170 | HPVA T-15034 (2015) |
| Spruce, Western White | 45/B | | 120 | HPVA T-15032 (2015) |
| Tamarack | 35/B | | 90 | HPVA T-15393 (2017) |
| Walnut | 75/B | 1010 | 125 | HPVA T-14526 (2014) |

Table 2 documents the flame spread characteristics of composite lumber building materials constructed from various wood products.

TABLE 2
Reported Characteristics of Composite Lumber Products

| | | | | |
|---|---|---|---|---|
| | ASTM E84 | | ASTM E84 | |
| | Flame | Flame | Smoke | |
| | Spread | Spread | Developed | |
| Material | Index | Class | Index | Source¹ |

ORIENTED STRAND BOARD (Exterior Glue)

| | | | | |
|---|---|---|---|---|
| 5/16″ | 127-138 | C | 155-171 | APA (1985) |
| 3/8″ | 100 | C | 95 | HPVA T-15116 (2016) |
| 7/16″ | 115-155 | C | 75-130 | APA 8901-8 (1989) |
| 15/32″ | 100 | C | 80 | HPVA T-15117 (2016) |
| 1/2″ | 75-172 | C | 109-194 | APA (1985) |
| 19/32″ | 175 | C | 95 | HPVA T-14312 (2013) |
| 23/32″ | 100 | C | 60 | HPVA T-15118 (2016) |
| 3/4″ | 147-158 | C | 111 | APA (1985) |
| 1-1/8″ | 110 | C | 115 | HPVA T-15298 (2016) |

SOFTWOOD PLYWOOD (Exterior Glue)

| | | | | |
|---|---|---|---|---|
| 1/4″ | NA | C | 55-200 | UL R6829 (1973) |
| 3/8″ | NA | C | 22-144 | UL R6829 (1973) |
| 1/2″ | NA | C | 55 | UL R6829 (1973) |
| 19/32″ | 95 | C | 50 | HPVA T-14311 (2013) |
| 5/8″ | NA | C | 50-85 | UL R6829 (1973) |
| 1/4″ Douglas-fir Plywood | 85 | C | 70 | HPVA T-15293 (2016) |
| 3/8″ Douglas-fir Plywood | 65 | B | 60 | HPVA T-15295 (2016) |
| 15/32″ Douglas-fir Plywood | 40 | B | 50 | HPVA T-15114 (2016) |
| 23/32″ Douglas-fir Plywood | 35 | B | 55 | HPVA T-15294 (2016) |
| 11/32″ Southern Pine Plywood | 75 | B | 115 | HPVA T-15113 (2016) |
| 15/32″ Southern Pine Plywood | 95 | C | 135 | HPVA T-15297 (2016) |
| 23/32″ Southern Pine Plywood | 65 | B | 175 | HPVA T-15296 (2016) |

HARDWOOD PLYWOOD

| | | | | |
|---|---|---|---|---|
| Ash 3/4″ - Particleboard Core | 135 | C | 80 | HPVA T-9344 (1995) |
| Birch 1/4″ MDF Core | 120 | C | 200 | HPVA T-14750 (2015) |
| Birch 1/4″ - Douglas Fir Veneer Core | 115 | C | 40 | HPVA T-14911 (2015) |
| Birch 1/4″ - Fuma Veneer Core | 125 | C | 15 | HPVA T-9665 (1996) |
| Birch 1/4″ - High Density Veneer Core | 165 | C | 65 | HPVA T-9234 (1995) |
| Birch 1/4″ - Poplar Veneer Core | 110 | C | 15 | HPVA T-14697 (2015) |
| Birch 3/4″ - Combination Core | 90 | C | 120 | HPVA T-14691 (2015) |
| Birch 3/4″ - High Density Veneer Core | 115 | C | 50 | HPVA T-9317 (1995) |
| Birch 3/4″ - Particleboard Core | 125 | C | 100 | HPVA T-9431 (1995) |
| Birch 3/4″ - MDF Core | 120 | C | 110 | HPVA T-14917 (2015) |
| Birch 3/4″ - Aspen Veneer Core | 135 | C | 70 | HPVA T-14700 (2015) |
| Birch 3/4″ - Baltic Birch Veneer Core | 120 | C | 70 | HPVA T-14694 (2015) |
| Birch 3/4″ - Douglas Fir Veneer Core | 70 | B | 55 | HPVA T-14704 (2015) |
| Birch 3/4″ - Poplar Veneer Core | 95 | C | 140 | HPVA T-14689 (2015) |
| Birch 3/4″ - Russian Birch Veneer Core | 110 | C | 70 | HPVA T-14764 (2015) |
| Lauan 1/4″, prefinished | NA | C | NA | DOC Tech. Note 945 (1977) |
| Mahogany 3/4″ - High Density Veneer Core | 105 | C | 90 | HPVA T-9354 (1995) |
| Maple 1/4″ Douglas Fir Veneer Core | 130 | C | 45 | HPVA T-14910 (2015) |
| Maple 1/4″ Poplar Veneer Core | 170 | C | 55 | HPVA T-14695 (2015) |
| Maple 3/4″ Combination Core | 100 | C | 85 | HPVA T-14706 (2015) |
| Maple 3/4″ MDF Core | 130 | C | 70 | HPVA T-14763 (2015) |
| Maple 3/4″ Particleboard Core | 85 | C | 75 | HPVA T-14912 (2015) |
| Maple 3/4″ Aspen Veneer Core | 180 | C | 75 | HPVA T-14699 (2015) |
| Maple 3/4″ Baltic Birch Veneer Core | 125 | C | 70 | HPVA T-14693 (2015) |

Tables 1 and 2—source: American Wood Counsel: “Flame Spread Performance of Wood Products Used for Interior Finish.”

Boron-based flame and fire resistance treatments for wood are known, both for surface application (e.g. painting) and impregnation (e.g. pressure treating or soaking). Generally, higher fire resistance classifications are only provided by high concentrations of boron impregnation, or the admixing of boron-based compounds with other fire resistive compounds. Studies have shown that a class II flame spread resistance is achieved with a 5.0% loading level, with a 7.5% loading required for class I flame spread resistance [“The role of boron in flame-retardant treatments,” LeVan and Tran, US Forest Service]. It is well known that boron-based treatments in higher concentrations cause problems with adhesive adherence [Japanese patent JP4369411B2, among others], limiting the use of boron-based retardants in glue laminate materials.

### 3.2.2 Bamboo Materials

Bamboo is a woody-grass comprising a hollow stem, called a culm, which comprises the internode and nodal portions. The internode comprises longitudinal fibers, longitudinal fluid (metaxylem) vessels, and is divided by solid diaphragmatic nodes spaced along the length of the stem. Bamboo fiber density (and structural values) vary within the walls of the culm, with the greatest density and strength found in the culm along the outer wall of the culm (e.g. the epidermis) and the lowest structural values along the inner wall of the culm (e.g. the pith). The diaphragmic nodes comprise a combination of radial fibers, and other structures that cross link the longitudinal fluid vessels of the internodes. Bamboo has a high longitudinal compression strength and a high modulus of elasticity because of the longitudinal fibers in the culm; the thickness of the culm greatly affects the mechanical properties of the bamboo. Various species of bamboo have much higher structural values than the wood typically used for wood studs; specifically, bamboo has a high longitudinal compression strength and a high modulus of elasticity as a result of its structure and the long (1.5-4 mm) fibers in the culm. The inner and outer layers of the culm are hydrophobic and resist fluid penetration, and the node structures pass only 7-8% of fluids across the node. This results in bamboo's being challenging to impregnate with fire and insect retardants, which is well known in the art.

### 3.2.2.1 Inflammability of Bamboo Building Products

Untreated bamboo, like softwood and hardwood, has a low fire rating because of its high heat release rate. The fire resistance of some species of bamboo has been tested and found to fall within the standard ranges found in structural woods [“Assessment of fire reaction and fire resistance of Guadua augustifolia kunth bamboo,” Mena, et. al.]

The efficiency of fiber-penetrating treatments for fire resistance depends upon the penetration of the chemicals into the bamboo culm tissue. The anatomical structure of bamboo culm makes it difficult to treat effectively, as bamboo is more resistant to chemical penetration than wood (Liese 1985, 1997). As referenced in various sources, the penetrability of the preservative is limited by the following anatomical characteristics of bamboo:

A) The metaxylem vessels are the main avenues of penetration and run in a strongly axial direction. They are isolated from each other by parenchyma in the internodes and connected only at the nodal diaphragm. The vessels are very small at the periphery of a culm wall and become larger in the middle and inner part. The vessel lumina on a transversal section amount to only 5-8%, in comparison with 70% lumina in softwoods and about 30% for diffuse hardwoods.

B) There are no radial pathways, like the medullary ray cells in wood, in culm tissue. The horizontal movement of preservative from the vessels into the neighboring tissue of parenchyma and fibers is only by diffusion.

C) Radial penetration through the outer culm wall is resisted by the skin with its epidermis and waxy apposition. Also, diffusion from the pith cavity is hindered by the solid sclerenchymatous (pith) tissue.

### 3.2.2.2 Issues with Treatment to Prevent Insect Attack

Bamboo is susceptible to insect attack, especially powder post beetle. The standard treatment to provide resistance to insect attack in the bamboo industry is heat treatment; however, heat treatment can negatively impact the structural performance of the bamboo by making it brittle.

Treating bamboo chemically, using a borate-based penetrating solution under vacuum and pressure, requires a high 6-8% solution of borate to provide the needed 0.2-0.3% tissue saturation protection from beetle attack, but the method suffers from consistency of penetration challenges and that protective solutions leech from the bamboo if used in wet environments.

### 3.2.2.3 Issues with Existing Engineered Bamboo Lumber Construction Techniques

Engineered bamboo lumber and panels are constructed of one more pieces of bamboo culm, glued together using traditional glue lamination techniques. Engineered bamboo lumber and panels converts “raw” bamboo culm (round, hollow) into materials that can be used as input materials for building and construction uses. There have been several attempts at producing acceptable engineered bamboo lumber and panels; each has deficiencies that produce materials that have substantial flaws that limit their utility.

A first approach to creating engineered bamboo lumber and panels is to use “thin walled” bamboo species, which is harvested, dried, crushed/flattened, machined to consistent thickness, and then glue-laminated into sheets resembling traditional plywood. The crushed bamboo culms and mats are irregular in shape, have numerous cracks and voids, which must be filled with glue during the manufacturing process. The resulting glue-laminate bamboo composite has a high glue to bamboo ratio, increasing its density (and thus weight), and changing its mechanical characteristics away from the characteristics of unaltered bamboo. The cracks and voids also weaken the resulting composite lumber and panels as they are filled with glue that does not have the structural characteristics of bamboo fiber. These laminated products also are limited in the amount of fire-proofing and insect-proofing compounds that can be impregnated into the bamboo fibers.

A second technique is to “peel” the wall of the bamboo culm and the flatten it. Again, like the crushing technique described above, the resulting bamboo mat suffers from numerous cracks and voids

In both examples, the resulting glue-laminate bamboo lumber has high glue to bamboo ratio as glue is used to fill the voids caused by the splits, cracks, and rounded portions of the source bamboo. Again, this process changes the mechanical characteristics away from the superior characteristics of unaltered bamboo.

In sum, each of the references previously disclosed herein highlights specific deficiencies in the known art. Specifically, it has been found that the production methods crack and split the bamboo culm, resulting is weaknesses in resulting bamboo building materials. A better method of processing bamboo culm and creating bamboo-based structural building materials is needed.

### BRIEF DESCRIPTION OF THE DRAWINGS

The features of the present technology will best be understood from a detailed description of the technology and example embodiments thereof selected for the purposes of illustration and shown in the accompanying drawings in which:

FIG. 1 depicts a cross-section of a bamboo culm that is 149 mm in diameter, illustrating how slats are cut out of the circumference.

FIG. 2 depicts a process flow and diagrams illustrating the manufacturing process for the solid bamboo slats.

FIG. 3 depicts the construction details for manufacturing edge-bonded bamboo veneer sheets from the solid bamboo slats.

FIG. 4 depicts the construction details for manufacturing edge- and face-bonded bamboo boards using solid bamboo slats.

FIG. 5 depicts construction details for manufacturing face-bonded bamboo boards using solid bamboo slats.

FIG. 6 depicts construction details for manufacturing bamboo panel layers using bamboo slats.

FIG. 7 depicts construction details for manufacturing cross-laminated panels from bamboo and/or wood panel layers.

### DETAILED DESCRIPTION

### 5.1 Overview

Giant clumping bamboo is the fastest growing plant on earth and as such is likely the fastest natural way to draw down carbon dioxide from the atmosphere to mitigate and reverse the climate crisis. Depending on the tree species, it takes 5-12 acres of trees to produce the same amount of building material as an acre of giant clumping bamboo.

Bamboo is a perennial plant living 60-100 years and can be harvested every year once mature, creating annual income for farmers and indigenous populations without killing the bamboo plant. Trees are killed when they are harvested, and trees used to produce solid wood lumber can only be harvested every 30-40 years.

Giant clumping bamboo does not spread from where it is planted and can be introduced to support the regrowth of native forests and increase biodiversity in deforested areas.

The large size of the giant clumping bamboos makes the material cost competitive with wood for construction which is necessary to address deforestation on a large scale.

### 5.2 Construction Techniques

The bamboo-based structural building material disclosed herein comprises bamboo slats cut from large diameter, thick walled bamboo culm selected from the following bamboo species: Guadua angustifolia, Phyllostachys edulis, Dendrocalamus asper, Dendrocalamus giganteus, Dendrocalamus brandisii, and Dendrocalamus sinicus. These species are characterized by culm wall thicknesses of between 10 and 60 mm, and culm diameters of 100 mm-150 mm.

The processing methods for bamboo disclosed herein improve upon the industry standard processing techniques, resulting in unexpected results of significant improvements in flame spread, fire resistance, mechanical characteristics, and usability of bamboo materials for building material purposes. The improved bamboo material can be assembled into engineered structural components with improved mechanical characteristics as described herein. The method of cutting the culm into slats provides benefits during subsequent processing, which results in a fire resistant solid bamboo slat.

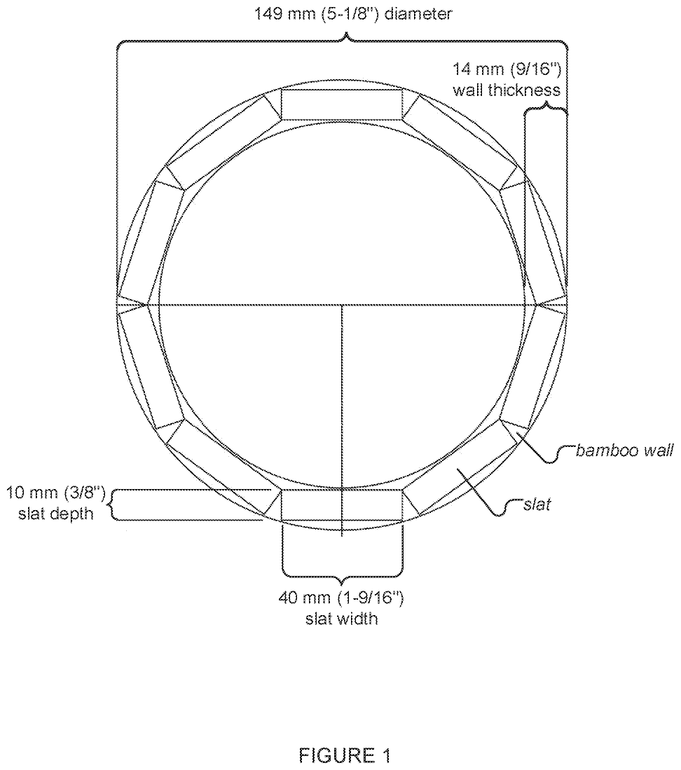

The raw bamboo culm is cut and processed by cutting the culm into regularly dimensioned bamboo slats. An example cross section cut plan for creating a bamboo slat of 10 mm in depth (thickness), and 40 mm in width is shown in FIG. 1. Each section of the culm produces 8-12 solid bamboo slats, depending upon the desired size of the solid bamboo slats and the diameter and wall thickness of the input culm. Slat sizes vary, and range in width from 5 mm to 50 mm, and in width from 25 mm to 100 mm. Note that traditional lumber sawing plans and machinery rely on the lumber being solid all the way through, as opposed to having the hollow center of bamboo culm.

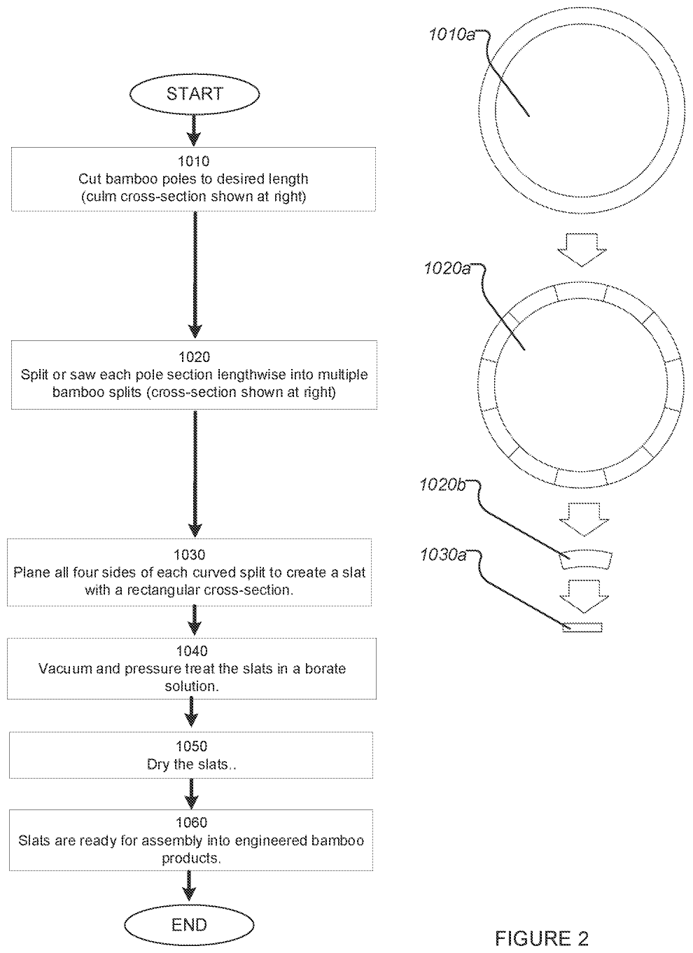

FIG. 2 depicts a process flow and diagrams illustrating the manufacturing process for the solid bamboo slats. This technique produces solid bamboo slats up to 100 feet long, based upon the length of the input bamboo culm. Typical usable sections of bamboo culm ranges between 50 to 100 feet in length, so slats of 50, 75, or 100 feet in length may be cut from a culm. The resulting solid bamboo slat may be cut to any needed length to facilitate material handling; typical lengths are 8 feet, 12 feet, and 16 feet. Longer slats, up to the full length of the culm, are advantageous for creating larger bamboo panels as there are fewer joints between slats (particularly for mass timber assemblies).

In step 1010, poles of giant clumping bamboo are cut into sections having a desired input length. Diagram 1010a depicts a cross-section through the culm, as it would appear when cut.

In step 1020, each pole section is sawed lengthwise into multiple bamboo splits. Diagram 1020a accompanying this step depicts the vertical divisions through the culm to produce (in this example) 12 splits. Diagram 1020b depicts the cross-section of an individual bamboo split, which has a curved profile.

In step 1030, all four sides of the split are planed to create a bamboo slat with a rectangular cross-section, as depicted in diagram 1030a. Additional planing and shaping may be performed on slat edges to add a scarfed edge (e.g. tongue and groove, finger joints) without deviating from the scope of the invention. Depending upon the size of the culm used as a source material and the cutting pattern, the resulting solid bamboo slats vary in depth from 7-14 mm, vary in width 22-40 mm, and vary in length as described above. Typical solid bamboo slat widths are 22 mm (⅞″) and 40 mm (1 9/16″), with typical solid bamboo slat depths of 7 mm (¼″) and 10 mm (⅜″). Other solid bamboo slat dimensions are possible if larger culm are selected. In a particular embodiment, the finished dimensions of a solid bamboo slat are ¾″ thick×1¼″ wide×8′ long.

Cutting solid bamboo slats in this manner offers several advantages over traditional processing methods. First, the resulting solid bamboo slats have consistent structural characteristics because the inner and outer portions of the culm are removed during cutting, resulting in bamboo slat fiber integrity that is not broken during processing (as is the case when the bamboo material is crushed or peeled). Each bamboo slat is a solid piece of bamboo culm with consistent structural characteristics along its length, without splits or breaks that weaken it, or non-square faces that weaken resulting engineered bamboo lumber products constructed from it.

Additionally, giant clumping bamboo slats are naturally clear of knots, unlike the Douglas fir and pine typically used to make CLT and LVL. The clear surface of the bamboo provides an aesthetic value to the CLT and LVL materials and can save construction costs by eliminating the need for the application of additional surface coverings or the need to face the panels and beams with costly clear wood, which often comes from endangered old growth forests. The higher density of the bamboo means that it will take a finish better than the softwood typically used. The bamboo will finish like a hardwood rather than a softwood, thereby adding additional value and beauty to the materials. The combination of the higher density and hardness of the bamboo over the Douglas fir and pine typically used to make CLT and LVL results in better fire resistance for the bamboo engineered lumber and panels than for hard- and softwood lumber and panel for ignition, flame spread and fuel contribution.

In step 1040, the solid bamboo slats are treated with a boron compound mixture as described below, and then dried (step 1050). Alternatively, the raw bamboo poles (culm) may be treated in a similar manner prior to cutting into slats.

The bamboo slats and/or bamboo poles are pressure treated using a 6-8% borax solution. The treatment solution comprises 221 kg of boric acid, such as is commercially available as Optibor from US Borax, 332 kg of concentrated sodium borate, such as is commercially available as Neobor from US Borax, and sufficient water to produce 7900 liters of a 6-8% borax solution. The bamboo material to be treated is loaded into a pressure treatment vessel, and an initial vacuum of (−0.6 bar, 550 mm hg) is applied for 50 minutes. The pressure treatment vessel is filled with the borax solution, and the pressure is increased to 8 kg/cm (which takes approximately 50 minutes). The pressure is then held at 8 kg/cm for an additional 40 minutes; then the pressure is released, the pressure treatment vessel drained, and a vacuum applied for 45 minutes. The treated bamboo materials are then removed from the pressure vessel and drained in a vertical position for 24 hours. Each batch of the resulting bamboo material is tested for boron concentrations using a commercial boron concentration test kit (available commercially from Hawk Creek Laboratories, Inc).

The boron-based preservative solution is saturated into the bamboo material to produce a 0.2-0.3% concentration. This concentration may impart insect resistance, fungus/rot resistance, and/or surprisingly, fire resistance and reduced flame spread characteristics to the treated bamboo slats. It is believed that the processing methods described for converting bamboo culm into slats, coupled with the pressure treating method described above, may improve the penetration and subsequent release of the boron-based preservative solution by exposing the bamboo's vascular network (e.g. larger fluid vessels in the middle of the culm and the radial channels in the nodes) as a myriad of pores, allowing the free flow of the impregnated boron-based preservative solution to be more available. The treatment produces a 0.2% concentration of boron, the level needed to protect the bamboo from powder post beetle attack.

These improvements in fire retardancy and flame spread may occur with substantially reduced concentrations of the boron-based preservative solution. This is contrary to previously understood experimental results and long-standing teachings. The treated slats, because of their reduced concentration of boron compounds, do not suffer the glue adhesion failures for materials subjected to higher concentration boron-based treatments.

Once completely processed (step 1060), the resulting solid bamboo slats are glue laminated in various combinations to produce larger engineered solid slat bamboo lumber and panel assemblies, including bamboo slat CLT panels, bamboo dimensional lumber, and bamboo mass timber products using a phenolic glue and standard glue laminating techniques. The resulting engineered lumber may be further treated using a calcium/magnesium/alumina/silicate mineral composition to further improve fire resistance and to achieve a different degrees of burn resistance rating, or the calcium/magnesium/alumina/silicate treatment may be applied instead of or before the boron-based treatment previously described.

In an embodiment, a calcium/magnesium/alumina/silicate mineral treatment compound may be applied to the exposed surfaces of the engineered bamboo lumber assemblies, either after or independently of any other treatment such as a boron-based treatment as described. For example, a mix of one third Portland cement; one third of a mixture of fine, medium, and rough silica sand; and one third water (all measurements by volume) may be used. Portland cement contains silicate and aluminate compounds, specifically tricalcium silicate, dicalcium silicate, tricalcium silicate, and tetra-calcium aluminoferrite. The ratios of these components may vary slightly without affecting the outcomes. The sand comprises 94% silica and approximately 4% of a combination of calcium, magnesium, and alumina. The increased water in the composition prevents the mixture from forming a mortar-like cementous substance and instead results in a mineral laden penetrating mixture.

The treated assembly is then dried, and any excess of the mixture is mechanically removed.

The application of the mixture is repeated for between two and four coats, with the treatment being allowed to dry and the excess dried residue removed after each treatment is applied. The treatment penetrates the exposed pores of the bamboo and the water evaporates, leaving a mineral residue behind to fill the pores. The level of pore occultation is determined by the number of coats of the treatment is applied and the size of the pores (which partially vary by bamboo species). The residual treatment is transparent or essentially transparent, leaving the natural aesthetic beauty of the bamboo grain visible. The filled pores act to prevent the borate impregnated in the bamboo from migrating when the bamboo is used in wet locations (or when the bamboo is exposed to flame) and provides significantly improved fire- and flame-spread resistance by forming a flame-resistant barrier within the bamboo itself.

The penetration of the calcium/magnesium/alumina/silicate mineral treatment is enabled by the removal of the hydrophilic outer layers of the culm during processing and the resulting exposure of the bamboo vascular system (as pores) as a result of the cutting process. A water-based or penetrant-based product could not penetrate the hydrophilic outer layers of bamboo-based engineered lumber products (the hydrophilic outer layers are generally the exposed faces of known engineered bamboo lumber) as previously described.

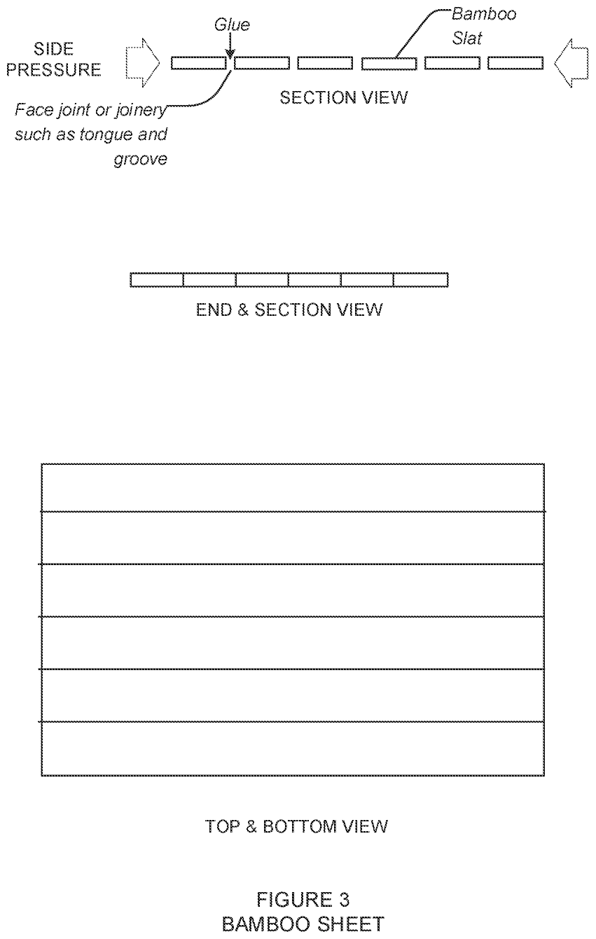

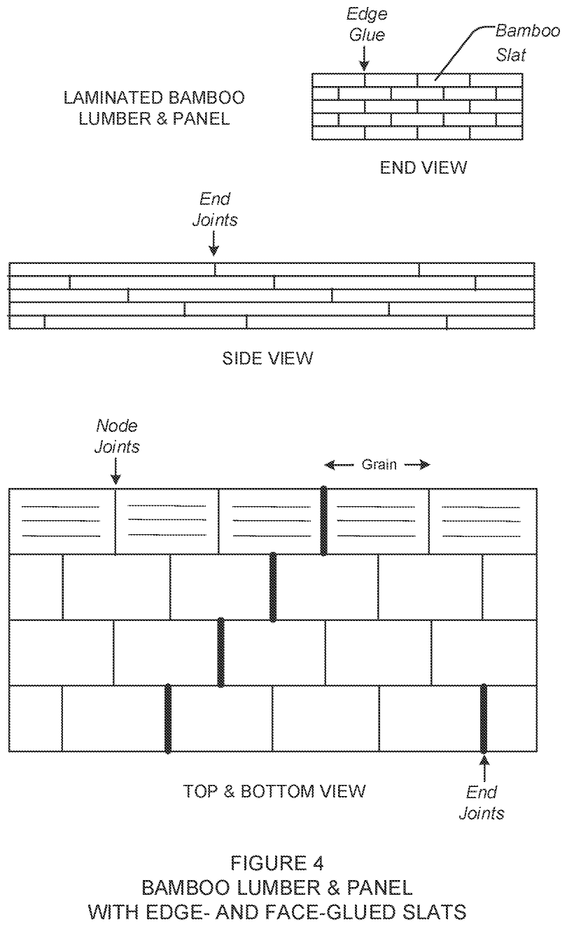

In one arrangement, a number of the rectangular solid bamboo slats are edge-bonded to produce wider glue-laminate engineered lumber, as depicted in FIG. 3. The edge-bonded joint may be butt jointed, or may use a scarfed interface such as those provided by tongue and groove joints. Alternatively, any known edge joining technique may be used (e.g. fingering, tongue and groove) to produce stronger edge-bonds. In embodiments, solid bamboo slats are face glued into sheets or are glued into multiple layers to create engineered bamboo lumber and panel of any dimension. Typical sheet sizes replicate the 4′×8′ plywood sheet common in the building industry; however, larger or smaller sheets may be constructed using these methods. Multiple sheets may be face glued in layers to produce thicker sheets creating bamboo timbers or bamboo CLT. In some embodiments, each of the multiple layers of the solid bamboo slats may be edge and face glued to produce an engineered bamboo lumber or panels (products) where the slat seams and bamboo internode locations within the product layers are offset from each other, as illustrated in FIG. 4, in order to produce products that have more consistent structural characteristics. In some embodiments, the slats may be arranged to place the grain of the slats in a desired orientation. For example, the slats may be arranged such that the grain of the slats is oriented parallel to a long axis of the panel. The orientation of the grain may vary between slats or, in building products that use multiple layers, between layers. More generally, any desired orientation may be used, such that the orientation of one set of slats differs from that of another.

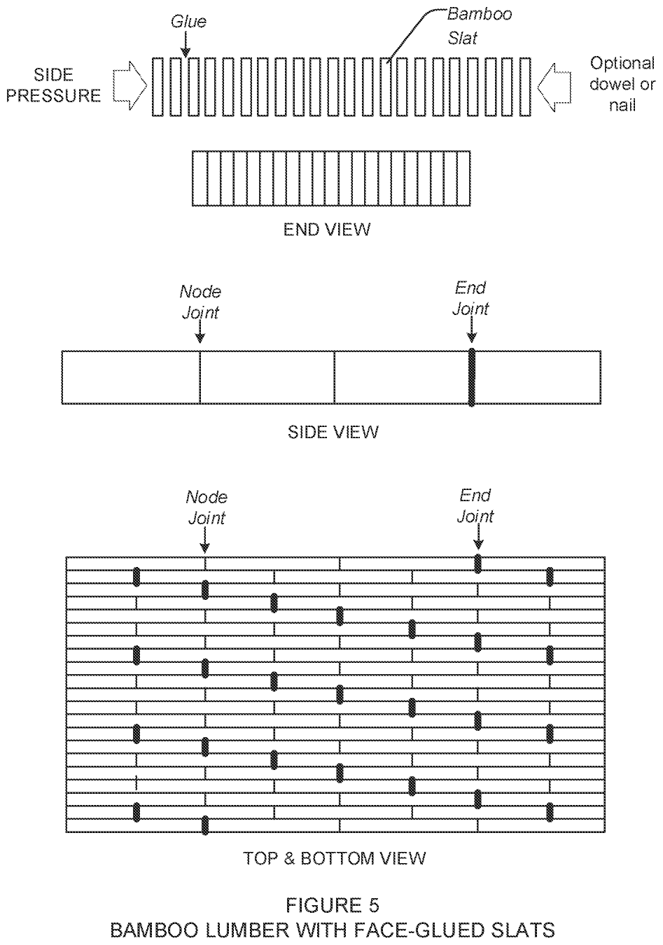

In another arrangement, the rectangular solid bamboo slats are face bonded to create thicker glue-laminate engineered bamboo lumber, as depicted in FIG. 5. In further arrangements, the engineered bamboo lumber is spliced to produce longer pieces. The edge and/or spliced joints are constructed using butt-end construction or any of the known joining techniques (e.g. finger joints, lap joints, scarf joints) to increase the joint strength.

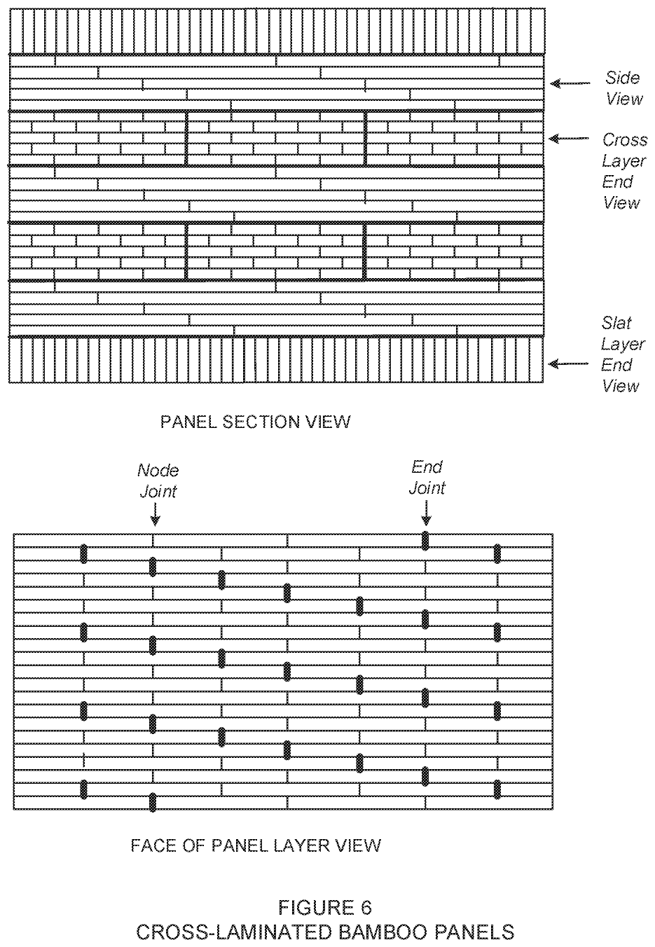

The bamboo lumber and panels depicted in FIGS. 4 and 5 may be cross-laminated to produce bamboo CLT panels, as illustrated in FIG. 6. Arrangements of bamboo slats and lumber other than the one depicted in the figure are possible without departing from the invention.

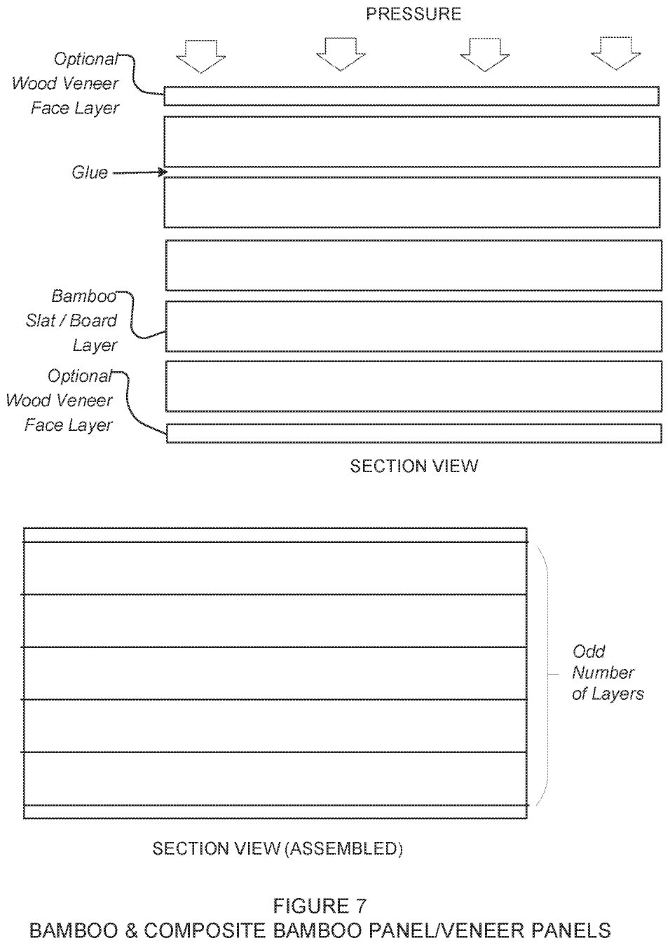

Composite assemblies of bamboo veneer layers and the cross-laminated bamboo CLT structures described above may be combined, pressed, and glued together to produce additional arrangements for panels or beams, as depicted in FIG. 7. In some of these arrangements, the face veneers or panel layers of these composite assemblies are bamboo or wood. In other arrangements, the orientation of the various panel layers may be alternated, skewed, or otherwise differ between subsequent layers based on the structural requirements of the panels and structural materials being manufactured.

Solid bamboo slat lumber assemblies may have superior structural characteristics over prior art glue laminates of wood and/or bamboo veneers because they are constructed using solid bamboo slats. The regular flat surfaces maximize adhesion of the glue, and the lack of cracks, voids, and broken fibers in panels and lumber constructed using solid bamboo slats are stronger and more flexible than existing bamboo glue laminates. Accordingly, the strength and density of solid bamboo slat glue laminates are superior to glue laminates constructed using traditionally flattened bamboo mats or sheets. The characteristics of the solid bamboo slat glue laminates more closely resemble the structural characteristics of intact bamboo and are superior to glue laminates constructed using traditionally flattened bamboo mats or sheets.

For example, a bamboo solid slat lumber may reduce the amount of material required when constructing beams and other load bearing structures using the methods described herein. MOE based deflection calculations demonstrate that when compared to a beam made of Douglas Fir, a solid bamboo slat beam requires at least 20% less material to carry the same structural load. In some cases, the solid bamboo slat beam requires at least 25% or even 30% less material than traditional wood beams (depends upon the MOE of the type of wood). Beams may be constructed in sizes up to 36 inches in depth (range 6″ to 36″), and up to 12 inches (range 4″-12″) in width, and to whatever length is requirement for the application.

CLT structural panels typically range in width from 2 feet to 10 feet, thicknesses up to 20 inches, and lengths up to 100 feet. When constructed using solid slat bamboo materials (either slats or lumber made from slats), solid bamboo CLT structural panels are both lighter and stronger than panels made of wood (particularly hardwoods and thin-walled bamboo glulam) due to their reduced density. In addition, the panels may be made with smaller dimensions and still support the same structural load, as described above for solid slat bamboo beams. Reductions in required load bearing dimensions of the solid bamboo CLT panel of 20%, 25%, or even 30% may be made, further reducing the weight of the resulting assembly. This results in a weight savings of between 30%, 40%, to 60% over comparable CLT panels constructed using hard or softwood.

In addition, the resulting bamboo structural materials inherit their insect, rot, and fire/flame spread resistance from the treated solid bamboo slats from which they are constructed. The bamboo structural materials herein may be treated with a mineral treatment to further enhance their fire and flame spread resistance characteristics, such as the calcium/magnesium/alumina/silicate mineral treatment previously disclosed herein.

Table 3 illustrates the superior structural and fire resistance/flame spread characteristics of the treated solid slat glue laminated bamboo material constructed as described herein over conventional materials.

TABLE 3

| | | | | | | | Thin-wail | | Glulam | | Thick wall | | Solid | |
|---|---|---|---|---|---|---|---|---|---|---|---|---|---|---|
| | | | | | Softwood | | bamboo | | thin-wall | | bamboo | | bamboo | |
| | Hardwood | | Softwood | | Glulam | | (untreated) | | bamboo | | (untreated) | | slat glulam | |
| Density | 300-1330 | g/cm³ | 0.4-0.7 | g/cm³ | Proportional | | 1.16 | g/cm³ | 6.86 | g/cm³ | 0.5-1.0 | g/cm³ | 0.74-0.76 | g/cm³ |
| | | | | | to the | | | | | | | | | |
| | | | | | density of | | | | | | | | | |
| | | | | | wood used | | | | | | | | | |
| Elasticity | 12.50-14.9 | GPa | 1.4-1.7 | GPa | 1.28 | GPa | 1.7 | GPa | 10 | GPa | 6.556 | GPa | 17-4-22.26 | Gpa |
| (MOE) | | | (Douglas Fir) | | | | | | | | | | (19.77 | Gpa) |
| | | | 4.48-13.6 | GPa | | | | | | | | | average. | |
| Maximum | 98.6-139.3 | MPa | 42.2-112 | MPa | 34.7 | MPa | 92.1 | MPa | 100 | MPa | 89.9 | MPa | 154.14 | MPa |

| Allowable | 86.1 | MPa | (average) | |
|---|---|---|---|---|
| Bending | (Douglas Fir) | | | |
| Stress | | | | |
| (MOR) | | | | |
| Compression | 3940 | psi | 7000-9000 | psi |
| | (27.1 | MPa?) | | |
| Shear | 6.27 | MPa | 11.72 | MPa |
| | (Douglas Fir) | | | |
| Janka | 600 | lbs/ft | 789.7 | lbs/ft |

| | | | | | | |
|---|---|---|---|---|---|---|
| Hardness | | 1650 | | | | |
| Fire | Class A-B | Class D-B | | Class E-D | Class D-C | Class A |
| Resistance | | | | | | |
| Class | | | | | | |
| Flame | See | See | See | | | 25 |
| spread | Table 1 | Table 1 | Table 2 | | | Class l/A |
| resistance | | | | | | |
| (ASTM-84) | | | | | | |

Structural testing revealed that the structural characteristics of the bamboo internodal sections exceed the above ratings, all failures occurred at slat joints or at locations where nodes were aligned.

A fire resistant glue laminated dimensional lumber may be created using treated solid bamboo slats assembled using standard glue lamination techniques. For example, varying the number of solid bamboo slats used permits the replication of the dimensions of traditional dimensional wood lumber to create an engineered fire resistant solid bamboo dimensional lumber of any of the following standard dimensions:

| Nominal | Dimensions |
|---|---|
| 2 × 4 | 1-1/2″ × 3-1/2″ |
| 2 × 6 | 1-1/2″ × 5-1/2″ |
| 2 × 8 | 1-1/2″ × 7-1/4″ |
| 2 × 10 | 1-1/2″ × 9-1/4″ |
| 2 × 12 | 1-1/2″ × 11-1/4″ |
| 2 × 14 | 1-1/2″ × 13-1/4″ |
| 4 × 4 | 3-1/2″ × 3-1/2″ |
| 4 × 6 | 3-1/2″ × 5-1/2″ |
| 6 × 6 | 5-1/2″ × 5-1/2″ |
| 6 × 8 | 5-1/2″ × 7-1/4″ |

In this way, the sizes of traditional dimensional wood lumber may be replicated in engineered solid slat bamboo lumber to be used wherever a piece of traditional dimensional wood lumber is used in construction. The specific dimensions and types disclosed herein are provided by way of example only. More generally, any desired dimensions of engineered fire-resistant solid slat bamboo lumber may be fabricated using the techniques, materials, and products disclosed herein.

In addition to solid slat bamboo-based fire-, rot-, and/or insect-resistant glue laminated structural products (e.g. bamboo-based CLT, LVL) and the fire, rot-, and/or insect-resistant solid bamboo dimensional lumber described above, the fire resistant bamboo slats (or engineered fire resistant solid bamboo dimensional lumber) may be directly assembled into “mass timber” elements using the same techniques as described above for solid slat bamboo-based CLT products. Mass timber products are typically limited in size by weight, structural loading, and shipping size constraints. The improved structural and weight characteristics of solid slat bamboo-based CLT products permits construction of mass timber elements (beams and panels) with substantial reduction in panel weight. Reductions of mass timber beams and panel weights of 30%, 40%, up to 60% over mass timber panels constructed of Douglas Fir or similar woods. The bamboo mass timber assemblies are treated as described above to provide fire and flame spread resistance to allow their use in construction as structural members without application of additional fire protection techniques (e.g. drywall cladding).

It will also be recognized by those skilled in the art that, while the technology has been described above in terms of preferred embodiments, it is not limited thereto. Various features and aspects of the above described technology may be used individually or jointly. Further, although the technology has been described in the context of its implementation in a particular environment, and for particular applications (e.g. fabrication of specific bamboo lumber products), those skilled in the art will recognize that its usefulness is not limited thereto and that the present technology can be beneficially utilized in any number of environments and implementations. Accordingly, the claims set forth below should be construed in view of the full breadth and spirit of the technology as disclosed herein.

What is claimed:

1. A fire-resistant and insect-resistant solid slat bamboo dimensional lumber board comprising a plurality of solid bamboo slats, wherein the lumber board is surface treated with a fire and flame spread resistance composition comprising calcium, magnesium, alumina, and silicate compounds.

2. The fire-resistant and insect-resistant solid slat bamboo dimensional lumber board of claim 1, wherein the surface treatment enters the exposed pores of at least one solid bamboo slat and at least partially occults the pores of the slat with the treatment compound.

3. The fire-resistant and insect-resistant solid slat bamboo dimensional lumber board of claim 1, wherein the surface treatment is applied between two and four times.

4. The fire-resistant and insect-resistant solid slat bamboo dimensional lumber board of claim 1, wherein the fire and flame spread resistant mineral composition comprises one-third part water, one third-part mixed size silicate particles, and one-third part water (by volume).

5. A fire and insect resistant bamboo panel comprising a plurality of solid bamboo slats, wherein the external surfaces of the panel are treated with a fire and flame spread resistance composition comprising calcium, magnesium, alumina, and silicate compounds.

6. The fire and insect resistant bamboo panel of claim 5, wherein the slats are arranged so that orientation of the grain of the slats is parallel to a long axis of the panel.

7. The fire and insect resistant bamboo panel of claim 5, wherein the slats are arranged so that orientation of the grain of the slats are differ between a first set of slats and a second set of slats.

8. A fire resistant and insect-resistant bamboo mass timber panel comprising a plurality of layers of solid slat bamboo lumber, wherein the lumber is arranged as a plurality of layers.

9. The fire resistant and insect-resistant solid slat bamboo panel of claim 8, wherein the layers have differing grain orientation between adjacent layers.

10. A fire resistant and insect-resistant bamboo mass timber panel, where the mass timber panel comprises a plurality of layers of solid slat bamboo panels.

11. A fire-resistant and insect resistant bamboo lumber panel comprising a plurality of solid bamboo slats, wherein the panel is surface treated with a fire and flame spread resistance composition comprising calcium, magnesium, alumina, and silicate compounds.

12. The fire-resistant and insect-resistant solid slat bamboo lumber panel of claim 11, wherein the surface treatment enters the exposed pores of at least one solid bamboo slat and at least partially occults the exposed pores of the slat with the treatment compound.

13. The fire-resistant and insect-resistant solid slat bamboo lumber panel of claim 11, wherein the surface treatment is applied between 2 and 4 times.

14. The fire-resistant and insect-resistant solid slat bamboo lumber panel of claim 11, wherein the fire and flame spread resistant mineral composition comprises of one-third part water, one third-part mixed size silicate particles, and one-third part water (by volume).

15. A fire-resistant and insect resistant bamboo mass timber panel comprising a plurality of solid bamboo slats, wherein the panel is surface treated with a fire and flame spread resistance composition comprising calcium, magnesium, alumina, and silicate compounds.

16. The fire-resistant and insect-resistant solid slat bamboo mass timber panel of claim 15, wherein the surface treatment enters the exposed pores of at least one solid bamboo slat and at least partially occults the exposed pores of the slat with the treatment compound.

17. The fire-resistant and insect-resistant solid slat bamboo mass timber panel of claim 15, wherein the surface treatment is applied between 2 and 4 times.

18. The fire-resistant and insect-resistant solid slat bamboo mass timber panel of claim 15, wherein the fire and flame spread resistant mineral composition comprises of one-third part water, one third-part mixed size silicate particles, and one-third part water (by volume).
